(19) United States
(12) Patent Application Publication
(10) Pub. No.: US 2008/0208645 A1
(43) Pub. Date: Aug. 28, 2008

(54) Method for Logic Tree Traversal

(75) Inventor: Sean Molloy, Parker, CO (US)

Correspondence Address: MERCHANT & GOULD PC, P.O. BOX 2903, MINNEAPOLIS, MN, 55402-0903, US

(73) Assignee: ControlPath, Inc., Englewood, CO (US)

(21) Appl. No.: 11/678,240

(22) Filed: Feb. 23, 2007

(51) Int. Cl. G06F 9/44

(52) U.S. Cl. 705/7

(57) ABSTRACT

Embodiments of the invention are directed to systems and methods for traversing a business object tree and an associated policy object tree. The traversal determines determine all ancestral business objects to any one business object of interest. The traversal also determines all policy objects associated with the ancestral objects or the business object of interest. The traversal algorithm may traverse the policy object tree to determine all policy controls linked to the associated policy objects. By traversing the business object tree and the policy object tree, the traversal algorithm provides a group of one or more policy controls associated with any one business item of interest.

### BACKGROUND

Organizations, such as business corporations, generally are required to conduct their activities under one or more “policies.” Policies are generally sets of methods, actions, directives, laws, ordinances, regulations, or plans developed and levied on an organization to meet the goals of governmental agencies or other institutions. For example, many manufacturing companies need to meet the standards of the International Organization for Standards (ISO) to be competitive as a quality manufacturer in the marketplace. Other examples of policies include Control Objectives for Information and Related Technology (COBIT), Sarbanes-Oxley Act, Environmental Protection Act regulations, etc. Each policy generally has one or more tasks or objectives that the organization must accomplish to comply with the policy.

Organizations generally have several different units, systems, or divisions, which may be referred to as “objects” and which may each need to apply the directives of the one or more policies. Attempting to determine which policy directives that each organizational object needs to follow is generally difficult. Often, an organization forwards the entire policy to the managers of the one or more organization objects and requires the manager to determine, from the policy, which objectives or tasks apply to their operations. This delegation method often creates a great deal of extra work for the manager that is separate from the core operations the organizational units in which the manager is in charge. In addition, the managers may often fail to identify or mistakenly overlook important policy objectives for which they need to adhere because the managers do not understand the interrelationships of the organization. For example, a manager may not understand or realize that a policy that applies to a parent organization also applies to his or her operations. As such, delegated policy tasks may get overlooked.

It is with respect to this general environment that the present invention, as embodied in the attached claims, is contemplated.

### SUMMARY

Embodiments of the present invention relate to systems and methods for associating one or more policy directives, also referred to as policy controls, with one or more objects of an organization. In embodiments, a directed cyclical graph, called a “business object tree,” models the organization and contains one or more links that represent dependencies, including interdependencies, within the organization. The one or more objects in the business object tree are associated with one or more policies, also referred to as policy objects, and contained in another directed cyclical graph called the “policy object tree.” The policy object tree contains objects representing each policy or policy section and one or more policy controls, which pertain to each policy object.

A traversal algorithm can traverse the business object tree and the policy object tree to determine all ancestral objects related to any business object of interest and all policy objects associated with the ancestral objects or the business object of interest. The traversal algorithm may traverse the policy object tree to determine all policy controls linked to the policy objects associated with either the ancestral objects or the business object of interest. By traversing the business object tree and the policy object tree, the traversal algorithm, in embodiments, provides a group of one or more policy controls associated with the business object of interest.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

Embodiments of the invention are hereinafter described with reference to the attached figures and drawings, where like reference numerals represent like items. A brief description of the drawings is as follows:

FIG. 1 is a block diagram of an embodiment of a business object tree that may be traversed to determine policy controls associated with one or more business objects.

FIG. 2 is a block diagram of an embodiment of a policy object tree that may be traversed to determine policy controls associated with one or more business objects.

FIG. 3 is a block diagram of an embodiment of a business object tree and a linked policy object tree that together may be traversed to determine policy controls associated with one or more business objects.

FIG. 4 is a block diagram of an embodiment of a business object tree and a linked policy object tree showing an example of a tree traversal that determines policy controls associated for a business object.

FIG. 5 is a flow diagram of an embodiment of a method for determining policy controls associated with one or more business objects.

FIG. 6 is a flow diagram of an embodiment of a method for traversing a business object tree and a related or linked policy object tree to determine policy controls associated with one or business object.

FIG. 7 is a block diagram of a software system for traversing business object trees and related policy object trees to determine policy controls associated with one or more business objects.

FIG. 8 is a block diagram of a computer system operable to execute a traversal algorithm.

FIG. 9 is a block diagram of an embodiment of a method for creating an object tree.

### DETAILED DESCRIPTION

This disclosure will now more fully describe some embodiments with reference to the accompanying drawings, in which only some of the possible embodiments are shown. Other aspects may be embodied in many different forms and should not be construed as limited to the embodiments set forth herein. Rather, these embodiments are provided so that this disclosure will convey the scope of the possible embodiments to those skilled in the art.

Embodiments of the present invention are generally related to systems and methods that determine which policy controls apply to which parts of an organization. Generally, the systems and methods generate a model of the organization and a model of the one or more policies that apply to any part of the organization. The two models are associated. In embodiments, an algorithm or other method is used to analyze the organizational model and the associated policy model to determine which policy controls apply to which parts of the organization.

Hereinafter, the organization described will be a business, but one skilled in the art will note that embodiments of the present invention can be applied to other entities and organizations. In embodiments, a business is modeled as one or more business objects in a directed cyclical graph called a business object tree. A business object may be any unit of the business (e.g., finance department, accounting, information technology, etc.), an asset of the business (e.g., a building, a server computer, networks, machinery, etc.), an employee (e.g., the chief executive officer, the director of security, a factory worker, etc.), vendors, business processes (e.g., security procedures, power loss recovery procedures, product assembly methods, etc.), or any other business related item. The business object tree, in embodiments, is a hierarchical model or description of two or more business objects that represents relationships between two or more business objects.

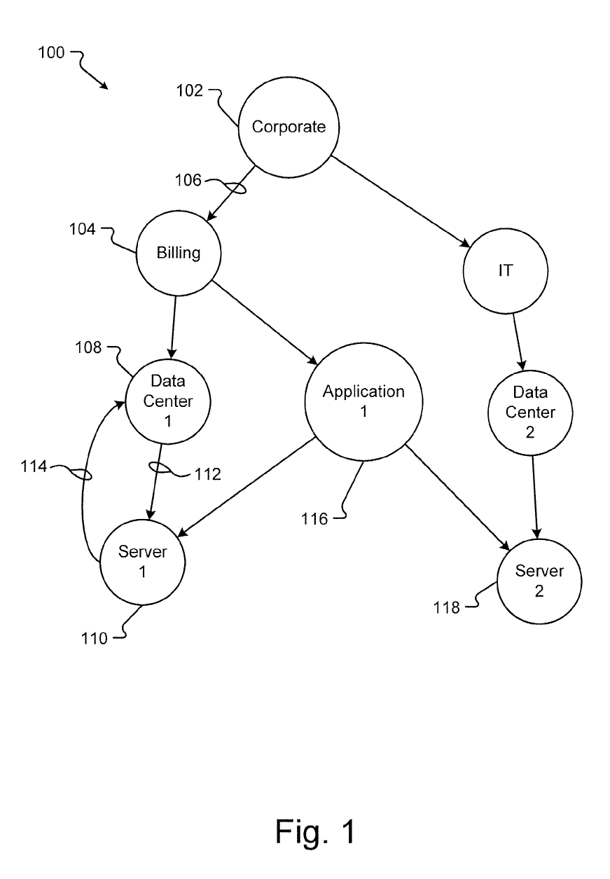

An embodiment of a business object tree 100 is shown in FIG. 1. In embodiments, the business object tree 100 has one or more nodes. A node is an entity in the business object tree and, in embodiments, the nodes represent business objects. For example, node 102 represents a corporate object. A node can have a relationship to one or more other nodes. For example, a node may be a child node (i.e., dependent on a higher order node) or a parent node (i.e., one or more lower order nodes depend on the node). A higher order node is any node above a selected node but linked to that selected node. In contrast, a lower order node is any node below the selected node that is linked to the selected node. Higher order nodes may also be referred to as ancestor nodes, while lower order nodes may be referred to as descendant nodes. For example, the corporate object 102, in the embodiment shown in FIG. 1, is the top node or is a higher order node than all nodes below the corporate object node 102. All other nodes in the business object tree 100 are descendant nodes of the corporate object 102 or are lower level nodes to the corporate object 102.

In embodiments, each node or object in the business object tree 100 is defined by one or more items of data in a database. The data may include, but is not limited to, a name or identification of the business object, an identification of the type of object (e.g., location, department, server, employee, etc.), and/or a list of user-defined attributes or values. The user-defined attributes may include any information or metadata desired by the user. In further embodiments, the node contains information about the nodes parent and/or children nodes. A user-defined attribute may be searched by a user to locate one or more business objects have the attribute. For example, a user-defined attribute may include a country designation, such as “Bangladesh.” A user could search for all business objects with the attribute “Bangladesh” and have returned a set of business objects with that attribute. For example, if a typhoon hits Bangladesh, a user could locate all business objects that may be affected by searching for the “Bangladesh” attribute. The user-defined attributes and searching allow users to create object trees that are more adapted to the user's application.

Relationships between nodes are represented by links between the nodes. For example, the corporate object node 102 is related or associated to its child node 104, the “Billing” object, by link 106. A link can provide an indication of the relationship between two nodes, which node is the parent object and which node is the child object. As such, a link may be “directional.” In embodiments, there exists one link between two nodes or objects, but, it is possible to have further links between the same nodes if different types of relationship exist between the nodes. Each object may have a link to two or more other objects such that one node can have multiple children nodes or multiple parent nodes.

In embodiments, a data element in a database represents the directional link between two nodes. The data element may have one or more items of data. An embodiment of the data element includes one or more of, but is not limited to, a parent identification, a child identification, a link type, and/or a link identification. The parent identification and/or the child identification can indicate the direction of the link. The link type may indicate the relationship between the nodes and can be used to traverse the business object tree for one or more types of relationships. For example, to determine the policy controls that apply to the business' facilities, the business object tree is traversed for all links having a “depends on” type of “facilities.” The link types may include, but are not limited to, facilities, computers, business units, etc., and may have relationships such as “located in,” “depends on,” etc. As with the business object attributes, the links may be searched or traversed according to the link type. For example, to find policy controls for only the buildings in the business, only links with a link type of “facilities” could be traversed. Thus, customized traversals are capable using the link type attribute.

Each node in the business object tree may inherit attributes from one or more of its ancestral nodes. For example, if a policy control applies to a parent object, the policy control would also apply to its child or descendant objects. By inheriting attributes, especially the associated policy controls, each node has a complete list of required attributes or policy requirements without needing to understand the structure of the higher order nodes in the business object tree.

The business object tree, in embodiments, is a directed cyclical graph (DCG). As explained above, the links or the nodes can describe the relationship between nodes, i.e., parent and child relationships. The relationship from a parent object to child object is directional. Further embodiments of the DCG business object tree represent cyclical relationships, or interdependencies, between nodes where a parent may also be a child of its child node. For example, the data center 1 object 108 is a parent of the server 1 object 110 as represented by directional link 112. However, server 1 object 110 is also a parent of data center 1 object 108 as represented by directional link 114. This “cyclical” relationship occurs often in businesses where objects are interdependent. For example, server 1 110 may be located in data center 1 108 and be dependent on data center 1 108. Likewise, data center 1 108 may be secured by a security system that requires a card scan system provided by server 1 110. Thus, data center 1 108 relies on server 1 110 and is in a child relationship with respect to server 1 110.

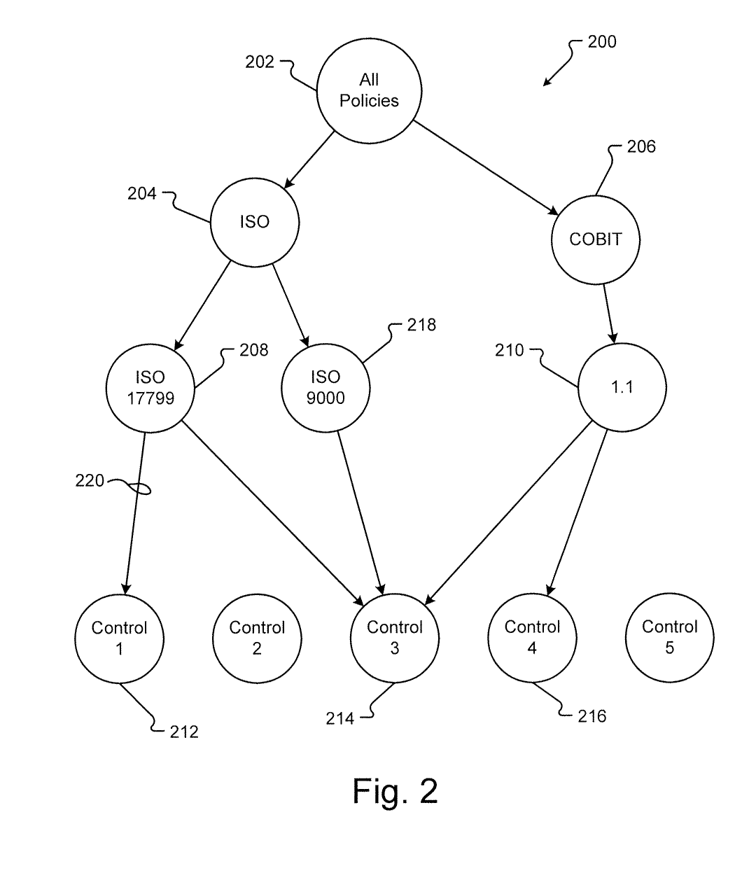

The policy model, in embodiments, is also a DCG called a policy object tree 200 having one or more policy objects as shown in FIG. 2. Like the business object tree 100 (FIG. 1), the policy object tree 200 can be a hierarchical model or description of one or more polices, with each policy having one or more policy objects. A policy object, e.g., the all policies object 202, in embodiments, is any grouping of policies (e.g., ISO standards policy group, COBIT, Sarbanes-Oxley Act, etc.), a discrete policy (e.g., ISO 9000, ISO 17799, etc.), or a section of a policy (COBIT section 1.1, EPA code chapters, etc.). In one embodiment, one or more policy controls, e.g., 212, 214, and 216, are the lowest level of the hierarchical policy object tree 200, and one or more policy objects are linked to or associated with the one or more policy controls, as represented by exemplary link 220.

The highest order policy object in the policy object tree 200 may be an all policies object 202. The children objects of the all policies object 202, in embodiments, are the policy type objects, for example, the ISO policy object 204 and the COBIT policy object 206. The policy type objects represent the types of policies that the business must follow. Each policy type object may have two or more policies as children objects. For example, the ISO policy type object 202 has the ISO 17799 policy object 206 as a first child and the ISO 9000 policy object 218 as a second child. Depending on the number of policies included in the group represented by the policy type object, a policy type object can have one or more children objects.

A policy object, in embodiments, may have one or more policy controls as children objects. For example, the 1.1 policy object 210 has the control 3 object 214 and the control 4 object 216 as children. A policy control object, in embodiments, represents a discrete task required by the parent policy object. One or more policy objects may share one or more policy controls. For example, the ISO 17799 policy object 208 shares policy control 3 214 with the 1.1 policy object 210. Both the IS0 17799 policy object 208 and the 1.1 policy object 210, in an example, may require “Doors to be locked nightly” (policy control 3 214) as part of the respective policies.

As with the business object tree 100 (FIG. 1), relationships between nodes are represented by links between the nodes. For example, the ISO 17799 policy object 208 is linked to or associated to its child node 212, the control 1 object, by link 220. The links in the policy object tree 200 can provide an indication of the directional relationship between two nodes, i.e., which node is the parent object and which node is the child object. Each policy object may have a link to two or more other objects such that one node can have multiple children nodes or multiple parent nodes.

In embodiments, a data element in a database represents the link between two nodes in the policy object tree. The data element may have one or more items of data. An embodiment of the data element includes one or more of, but is not limited to, a parent identification, a child identification, and/or a link type identification. The parent identification and/or the child identification can indicate the direction of the link.

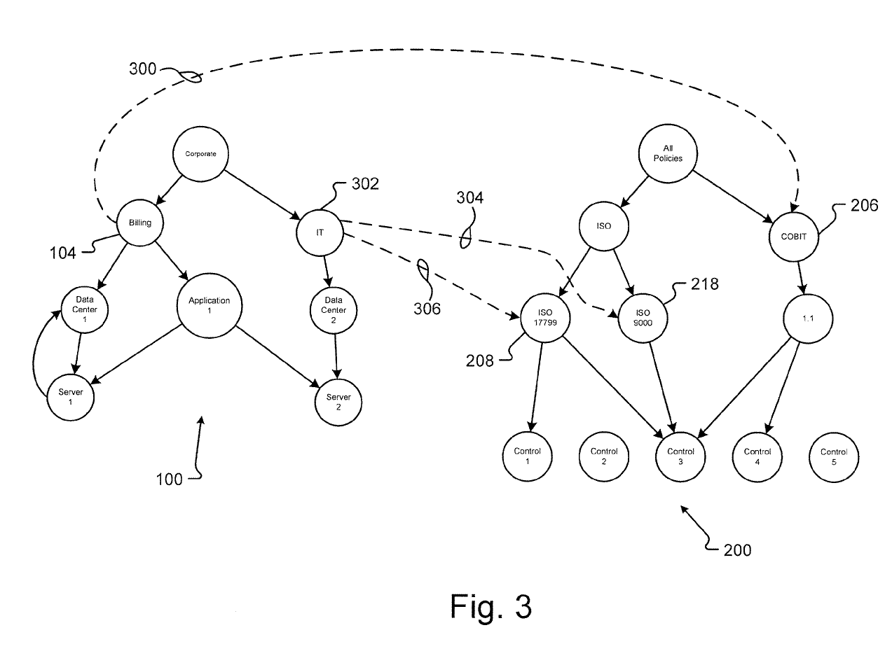

The business object tree and the policy object tree are interrelated or associated in embodiments, as shown in FIG. 3. One or more objects in the business object tree may be linked to or associated with one or more policy object in the policy object tree by one or more links. As such, the two trees are associated. For example, the billing object 104 in the business object tree 100 is associated with the COBIT object 206 in the policy object tree 200. The association or linkage between the billing object 104 and the COBIT object 206 is represented by link 300. In further embodiments, one business object has two or more links to two or more policy objects. For example, the IT business object 302 has two links 304 and 306 to two policy objects, the ISO 17799 object 208 and the ISO 9000 object 218, respectively. As such, the IT object 302 must adhere to policy controls associated with both policy objects 208 and 218.

In embodiments, the links between the business object tree 100 and the policy object tree 200 are data elements in a database, with each data element including one or more items of data. For example, the data items may include one or more of, but are not limited to, a business object identification, a policy object identification, a type, and/or an override bit. The override bit can prevent the inheritance of attributes from higher order objects. In some situations, inheriting the policy controls from ancestral nodes is inappropriate. For example, some countries may have laws that should be enacted instead of global guidelines from an international organization. In such situations, the override bit can be sent to prevent the international guidelines from being inherited from an ancestral object and only apply the laws of the country.

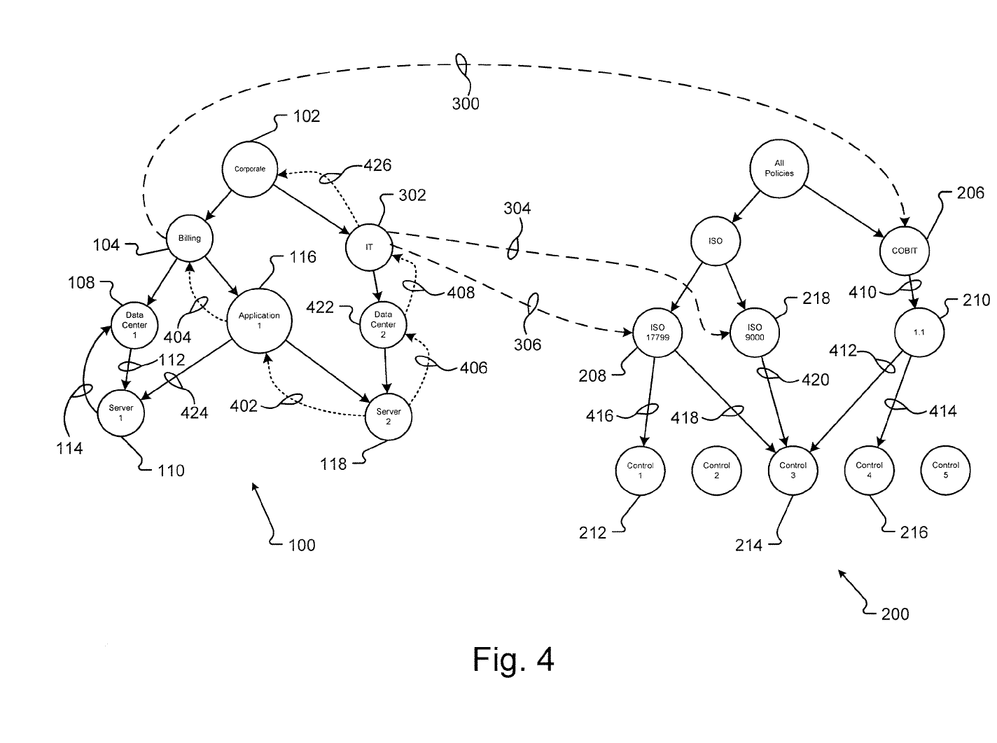

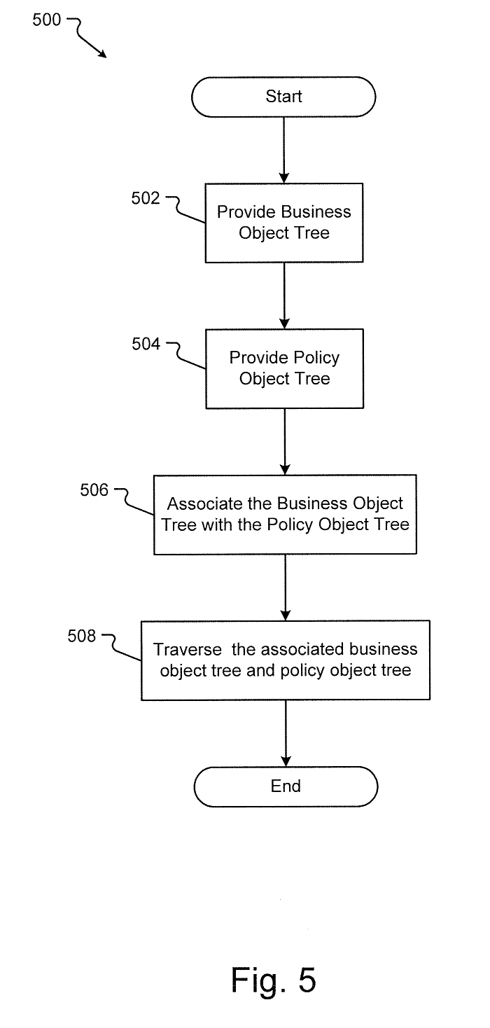

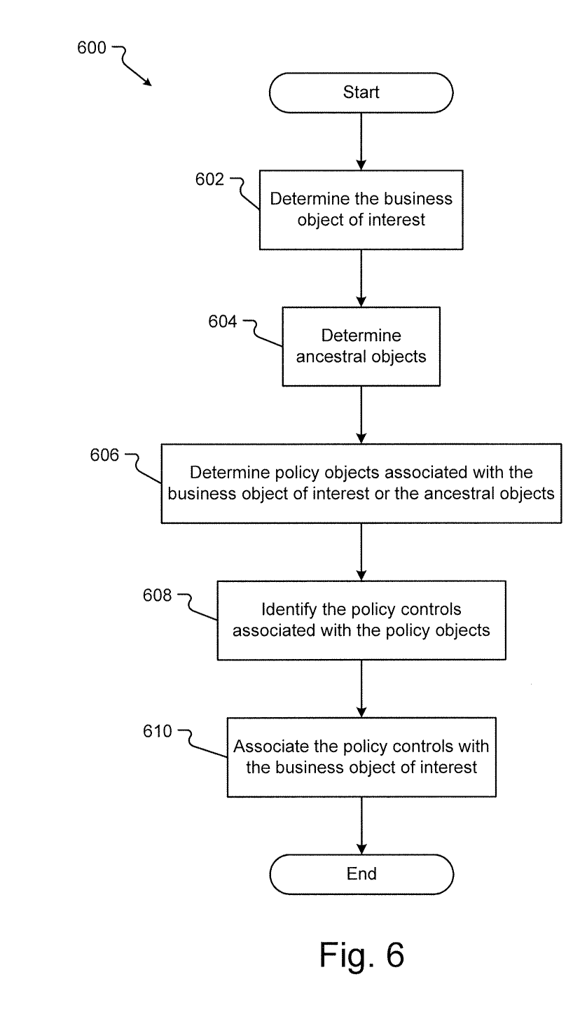

A block diagram showing a sample tree traversal is shown in FIG. 4. The business object tree 100 and the policy object tree 200 are as shown in FIGS. 1 and 2. The links 300, 304, and 306 are as shown in FIG. 3. The diagram of FIG. 4 will hereinafter be used for explaining methods 500 of FIG. 5 and method 600 of FIG. 6.

An embodiment of a method 500 for determining policy controls associated with one or more business objects is shown in FIG. 5. Provide operation 502 provides a business object tree. The business object tree 100 (FIG. 1) is, in embodiments, as described in conjunction with FIG. 1. The business object tree 100 (FIG. 1) may be created and stored in a database. In alternative embodiments, the business object tree 100 (FIG. 1) is already stored in memory of a computer system and retrieved for tree traversal.

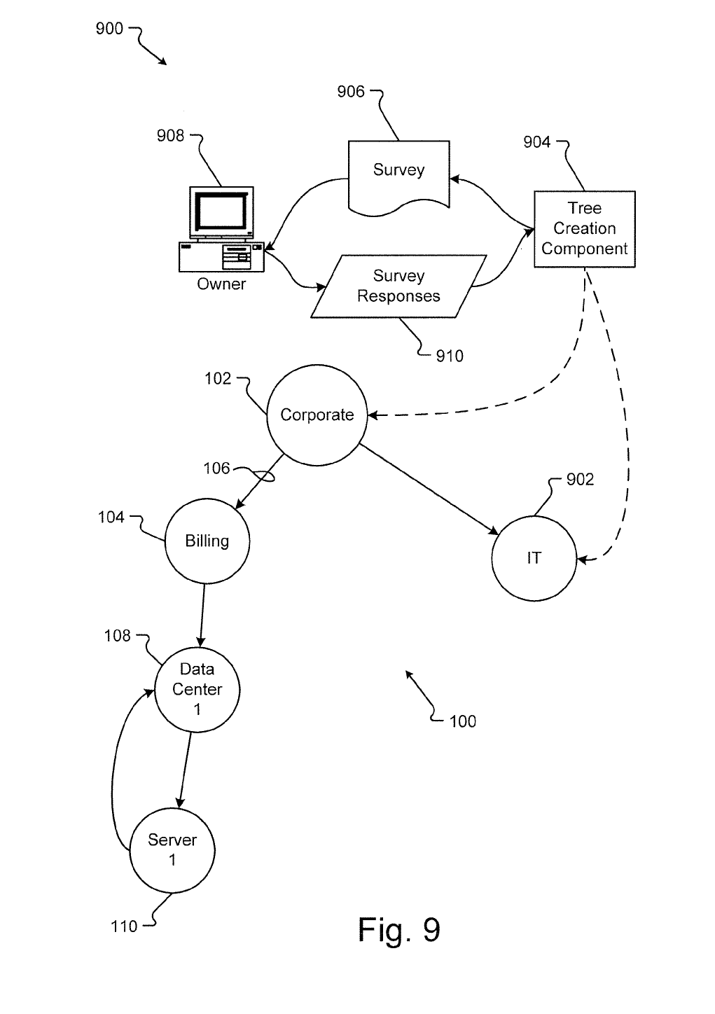

A representation of a process or method 900 for creating the business object tree 100 is shown in FIG. 9. In embodiments, an object owner, such as a corporate director or manager, is given, sent, or provided a survey 906 from a tree creation component 904. The owner of an object is a person who is knowledgeable about the business object in question and may have managerial responsibility for that business object. In one embodiment, the survey 906 and responses 910 are electronic, and the owner is thus represented by computer system 908. However, the surveys 906 and responses 910 may be given in paper form with the response data 910 entered into a computer system executing the tree creation component 904.

In the survey, the owner 908 of the corporate object 102, for example, the corporate director, may be asked, in the survey 906, what systems or business units that the corporation may depend or over which the corporation has control. In embodiments, the corporate director answers, in the survey responses 910, that the corporation, represented by the corporate object 102, controls the functions of the billing department and the IT department. The tree creation component 904 can then create two objects, the billing object 104 and the IT object 902, in the business object tree 900 in response to the corporate director's input. Links, such as link 106, are created to represent the relationship between the newly created objects, e.g., the billing object 104, and the corporate object 102.

The corporate director, in embodiments, describes who should be surveyed for the child objects, e.g., the billing object 104 and the IT object 902, by providing information as to the manager or owner of the business units that represent the child objects. Another survey 906 is sent to the owners 908 of the child objects. The same types of questions are asked of the billing object 104 owner 908 to create the data center 1 node 108 and, possibly, the server 1 node 110. The questions also identify the cyclical relationship between data center 1 object 108 and the server 1 object 110.

By interviewing the owners of the different business objects and forwarding surveys 906 to object owners for objects that are dependent on the higher order objects, a business object tree 900 may be generated organically and populated with information by people with the most knowledge, i.e., the object owners. In embodiments, the surveys 906 are electronic and are automatically forwarded. The response data 910 from the owners can be automatically saved, in embodiments, into a database to create the business object tree 100. In embodiments, the policy object tree 200 (FIG. 2) may be created in a similar fashion with the tree creation component 904. Further, additions or changes to the business object tree 100 may be recorded by resending the surveys 906 and noting the changes.

Provide operation 504 provides a policy object tree. The policy object tree 200 (FIG. 2) can be as described in conjunction with FIG. 2. Similar to the business object tree 100 (FIG. 2), the policy object tree 200 (FIG. 2) may be created and stored in a database or, in alternative embodiments, is already stored in memory of a computer system and retrieved for tree traversal.

Associate operation 508 associates the business object tree with the policy object tree. In embodiments, one or more links are created between one or more business objects and one or more policy objects. For example, the link 300 (FIG. 300) between business object 104 (FIG. 3) and policy object 206 (FIG. 3) is created. The one or more links may be created manually by a user by placing the business object identification and the policy object identification into a data element to create the link in a database.

Traverse operation 508 traverses the business object tree and the policy object tree to associate policy controls with one or more business objects of interest. In embodiments, the directional links between child and parent business objects, between business objects and policy objects, and between parent and child policy objects are followed until terminating at policy controls. One embodiment of a method for tree traversal is explained in conjunction with FIG. 6. In embodiments, the result of the tree traversal operation 508 is a list or group of one or more policy controls associated with one or more business objects. This group of associated policy controls may be provided to the user for help in identifying applicable policy tasks to enact. For example, a facilities manager who “owns” the responsibility for a building is provided with all the policy controls (e.g., doors must be locked at night, a card scan security system must be used, a semi-annual fire inspection must be completed, etc.) he must enact. The facilities manager does not need to research through several different policies to individually determine which policy controls apply to his or her building, but those policy controls are determined for the facilities manager and automatically provided.

An embodiment of a method 600 for traversing a business object tree and a policy object tree to associate policy controls with one or more business object is shown in FIG. 6. In embodiments, a traversal algorithm traverses the trees to associate the policy controls with the one or more business objects. Reference will be made to the business object tree and the policy object tree shown in FIG. 4 to better explain the embodiment of the method 600. In embodiments, determine operation 602 determines the one or more business objects of interest in the business object tree. Hereinafter, only one business object of interest will be described, but one skilled in the art will recognize how to expand the tree traversal to include more than one business object of interest. A business object of interest is any object that a user selects to designate that he or she desires to know what policy controls apply to that business object. In embodiments, the user enters, in a graphical user interface, the business object identification for the business object of interest.

Determine operation 604 determines one or more ancestral objects to the business object of interest. An ancestral object, in embodiments, is any higher order object that is associated with an object through one or more directional links whose direction is from child to parent. For example, a parent object is an ancestral object to the children of the parent object. Likewise, the grandparent objects of the children object are also ancestral objects, but a sibling object is not an ancestral object.

Referring to FIG. 4, the server 2 object 118 has five ancestral objects. The applications 1 object 116 and the data center 2 object 422 are both parent objects to the server 2 object 118 and are ancestral objects to the server 2 object 118. Further, the billing object 104 and the IT object 302 are both ancestral objects because both objects are grandparent objects to the server 2 object 118. The corporate object 102 is an ancestral object because it is a great grandparent object to the server 2 object 118. In contrast, the server 1 object while “related” is not an ancestral object because it is a sibling object. Sibling objects do not have a link that is in the proper direction, that is, from child to parent. Rather, the link to a sibling is from parent to child. For example, the link from the server 2 object 118 to the application 1 object 116 is child to parent. Yet, while the server 1 object is linked to the application 1 object via link 424, link 424 is in the wrong direction; that is, link 424 goes from the parent object, the application 1 object 116, to the child object, the server 1 object 110. Thus, the server 1 object 110 is a sibling to the server 2 object 118 and not an ancestral object.

In embodiments, some business objects have cyclical relationships where a child object is also a parent of its parent object. For example, as shown in FIG. 4, the data center 1 object 108 is the parent of the server 1 object 110 as represented by link 112. Yet, the server 1 object 110 is also the parent of the data center 1 object 108 as represented by link 114. In these cyclical relationships, it is harder to identify the ancestral object because both the server 1 object 110 is a parent of the data center 1 object and the data center 1 object 108 is a parent of the server 1 object 110. Thus, the traversal algorithm must determine in the cyclical relationships which object is the ancestral object. After determining that there is a cyclical relationship because of the unique parent and child relationship between two objects, the traversal algorithm, in embodiments, determines if one of the objects has another parent object. For example, the data center 1 object 108 has the billing object 104 as a parent. The object with other parent object, e.g., the data center 1 object 108, is considered the ancestral object.

After traversing a link, the link, in embodiments, is coded to indicate that link has been traversed, also referred to as “coloring the link.” In embodiments, an indicator flag or other data element is set to show the link has already been traversed. Coloring the link prevents the traversal algorithm from getting caught in an infinite cycle when trying to traverse cyclical relationships in the business object tree 100.

For example, if the server 1 object 110 is the business object of interest, the traversal algorithm would traverse the link 112 from the server 1 object 110 to the data center 1 object 108. After traversing the link 112, the link would be “colored.” Then, the traversal algorithm would recognize link 114 that is in the correct direction, from child to parent, and would traverse the link back to server object 1 110. Link 114 would also be colored. The traversal algorithm may then try to traverse link 112 again. However, link 112 was colored. As such, the traversal algorithm would be prevented from traversing link 112 again.

Determine operation 606 determines policy objects related with either the lowest order object or its ancestral objects. In one embodiment, the traversal algorithm searches for links between the business object of interest or its ancestral objects and one or more policy objects. For example, the billing object 104, in FIG. 4, has a link 300 to the COBIT policy object 206. In finding the links between the business objects and the policy objects, the traversal algorithm locates the one or more associated policy objects in the policy object tree 200.

Identify operation 608 identifies the one or more policy controls associated with the located policy objects. A traversal of the policy object tree, in embodiments, identifies the associated policy controls. As shown in the example in FIG. 4, the policy object tree 200 (FIG. 4), is traversed from parent to child (i.e., in the opposite direction of the traversal of the business object tree 100) to find the lowest order objects, which are the policy controls in the policy object tree 200. For example, the COBIT policy object 206 has a link 410 which is traversed to the 1.1 policy object 210. Then, links 412 and 414 are traversed to control 3 214 and control 4 216, respectively. Thus, two policy controls are identified for the COBIT policy object 206.

Associate operation 610 associates the identified or determined policy controls with the business object of interest. For example, after the traversal of the business object tree 100 and the policy object tree 200 shown in FIG. 4, one or more policy controls are determined to relate to one or more business objects. In embodiments, the determined policy controls are associated with the business object of interest with a data element in a database. The data element may have the identification of the business object of interest and one or more pointers to the one or more policy controls associated with the business object of interest.

In further embodiments, there may be one or more duplicate policy controls associated with the same business object. For example, the ISO 9000 policy object 218 and the 1.1 policy object 210 both link to control 3 214. As such, if a tree traversal occurs from both the ISO 9000 policy object 218 and the 1.1 policy object 210, then two instances of control 3 214 would be related to a business object. However, after all policy controls are determined, the traversal algorithm can eliminate the one or more duplicate controls and maintain one associated policy control with the business object of interest.

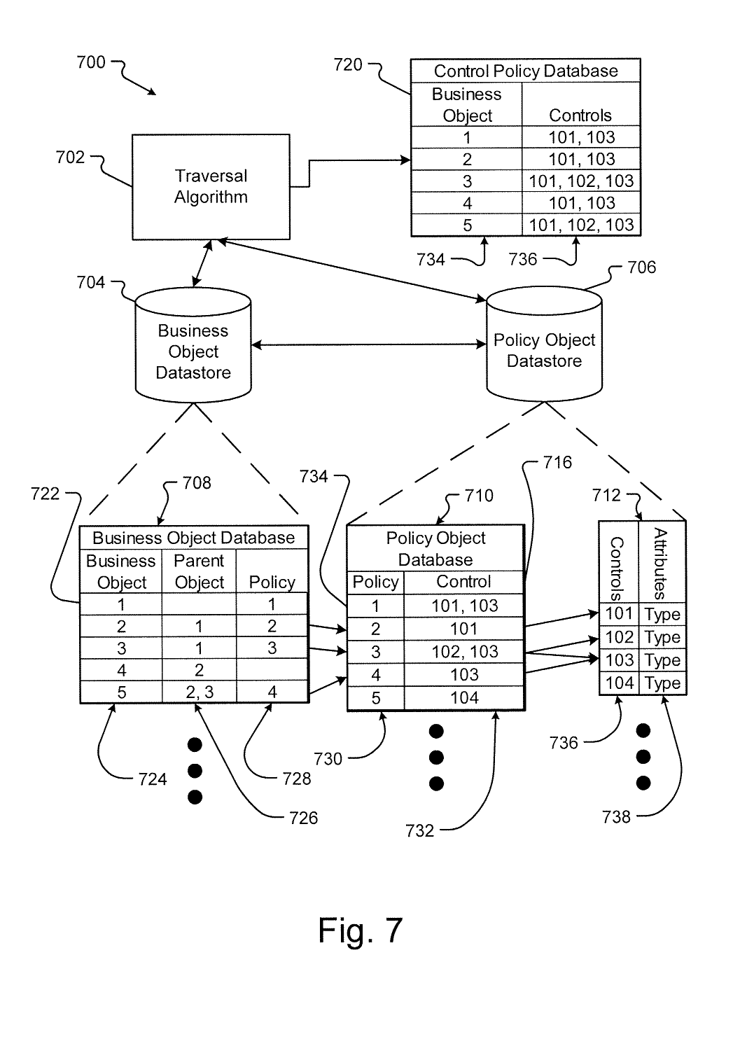

In still further embodiments, the policy controls may have one or more attributes. For example, each policy control may have an attribute designating a type of policy control and only predetermined types of policy controls apply to predetermined business objects. The policy controls and the policy control attributes, including the type attribute, may be provided in a policy control applicability table, explained in conjunction with FIG. 7. A business object representing a building may have an attribute designating it as a “facilities” type business object. After the tree traversal, several controls may be identified or determined for the building business object. However, only those policy controls with the type “facilities” would be associated with the building business object and those not related to “facilities” would be deleted. For example, a policy control to lock the doors at nights would be associated with a building business object, but a policy control to change passwords for a server system would not be associated with the business building object although the password policy control may be identified for the building business object. In alternative embodiments, each link between the business objects and the policy object has a type and only those links with a predetermined type are traversed. The links to certain policy controls also would have, in the example, a type attribute representing the applicability of the policy control to one or more business objects. As such, only those policy controls with the predetermined type would be identified rather than identifying all policy controls and only associating the correct type of policy control.

To further illustrate how the policy controls are related to the business objects, an example shown in FIG. 4 will hereinafter be explained. The server 2 business object 118 is determined to be the business object interest by selection from the user. Links are traversed from the server 2 object to its ancestral objects starting with the parent objects, the application 1 object 116 and the data center 2 object 422. The traversal of the links to the parent objects is represented by arrow 402 and 406, respectively. The application 1 object and the data center 2 object are determined to be ancestral objects. Further ancestral objects are then determined.

The IT object 302 is an ancestral object and traversed as evidenced by traversal 408 and the billing object is also an ancestral object as evidenced by traversal 404. The corporate object 102 is also an ancestral object, as represented by traversal 426. There are no other links that have a direction from child to parent in the chain of links between objects, and thus, no other ancestral objects are determined. The ancestral objects are found, notably, the data center 2 object 422, the application 1 object 116, the billing object 104, the IT object 302, and the corporate object 102. Any associations between any one of the ancestral objects or the server 2 object and a policy object can now be determined.

Only two objects from the group of ancestral objects or the business object of interest have links to the policy object tree. The billing object 104 is linked to the COBIT policy object 206 and the IT object 302 is linked to both the ISO 9000 object 218 and the ISO 17799 object 208. From these determined policy objects, the policy object tree 200 may be traversed. The policy controls associated with the COBIT policy object 206, the ISO 9000 object 218, and the ISO 17799 object 208 are determined. The links between the policy objects and the policy controls is traversed. In traversing the policy object links, three policy controls are determined to be associated with the COBIT policy object 206, the ISO 9000 object 218, and the ISO 17799 object 208. The COBIT policy object 206 is associated with policy control 3 212 and policy control 4 214; the ISO 17799 object is associated with policy control 1 and policy control 3; finally, the ISO 9000 policy object is associated with policy control 3. As such, there are one instance of policy control 1 associated with the server 2 object 118, three instance of policy control 3 associated with the server 2 object 118, and one instance of policy control 4 216 associated with the server 2 object 118. There are two duplicate instances of policy control 3 214, which are deleted. Therefore, the server 2 object 118 is associated with policy control 1 212, policy control 3 214, and policy control 4 216. This group of associated policy controls may be provided, by displaying or outputting the group of policy controls, to the user to enact the policy controls.

An embodiment of a software system 700 operable to associate policy controls with business objects is shown in FIG. 7. In embodiments, a traversal algorithm 702, similar to the traversal algorithm explained in conjunction with FIG. 6, accesses a business object datastore 704 and a policy object datastore 706. From the business object datastore 704, the traversal algorithm retrieves a business object database 708, which may include one or more data elements, e.g., data element 722, that have one or more data values. In one embodiment, each data element includes a business object identification 724, a parent object identification 726, and an identification of an associated policy object if applicable. In embodiments, the business object database 704 contains the business object tree 100 (FIG. 1) and the policy object database 706 contains the policy object tree 200 (FIG. 2).

The traversal algorithm 702 can traverse the business object tree, as represented by the business object database 708, as explained in conjunction with FIG. 6. Parents for a business object of interest are determined, by traversing the parent object links represented by the parent object identification 726, to create lists of ancestral objects. Once a list of ancestral objects is created, the traversal algorithm traverses the links, represented by the policy object links 728 to the policy object tree, as represented by policy object database 710 stored in the policy object datastore 706.

The policy object database 710 includes one or more data elements, e.g., data element 734, which each may have one or more data values for a policy object identification 730 and a pointer or link to a policy control 732. Another database element, in embodiments, is the controls group 712 that may also be stored in the policy object datastore 706. The link or pointer 732 in the policy object database 710 may point to the controls group 712. The policy object database 714 can be traversed to find a group of controls associated with each policy object of interest.

In alternative embodiments, the policy control group 712 represents a policy control applicability table 712. Both the policy controls 736 and one or more policy controls attributes 738 are contained within a policy control applicability table 712. An attribute 738 of the policy control 736 may be the type of attribute. The type of the attribute may function to associate only policy controls of a predetermined type with predetermined business objects.

Upon determining the policy controls, the traversal algorithm, in embodiments, provides and/or displays a control policy database 720 that associates the business object identification number 734 with one or more policy controls 736. The control policy database 720 may be provided to the user to identify the policy tasks or controls for which each owner of the business objects is responsible.

In alternative embodiments, a series of links between nodes is saved in a datastore with the same information as presented in the one or more databases in FIG. 7. For example, a link may contain a simple syntax, for example, “business object: parent object: policy object association: override: type.” Instead of searching the information in the databases, the traversal algorithm 702 uses the data from the links as one skilled in the art will recognize.

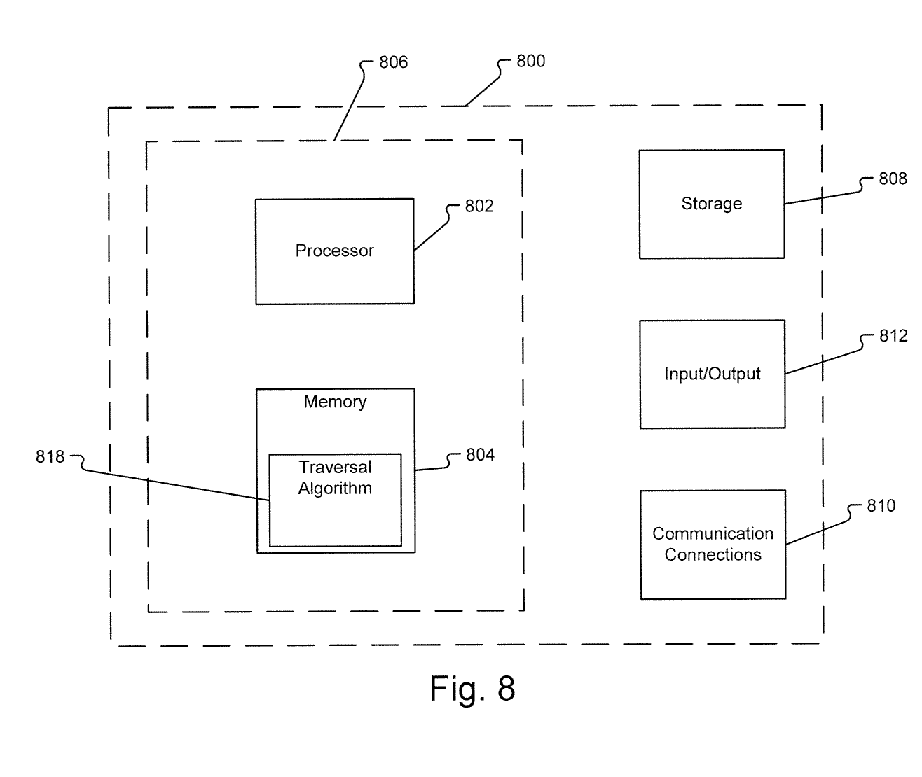

With reference to FIG. 8, an embodiment of a computing environment for implementing the embodiments described herein is shown. In one embodiment, the traversal algorithm 702 (FIG. 7) is a process executed in a computing system 800 such as a server, desktop, laptop, handheld device, or other computing system. Embodiments of the computer environment for the traversal algorithm 702 (FIG. 7) include a computer system, such as computer system 800.

In its most basic configuration, computer system 800 typically includes at least one processing unit 802 and system memory 804. In embodiments, a traversal algorithm component, generally indicated by 818, is loaded into memory 804 and run by the processing unit 802 from system memory 804 of a computer. Depending on the exact configuration and type of computer system 800, memory 804 may be volatile (such as RAM), non-volatile (such as ROM, flash memory, etc.), or some combination of the two. This most basic configuration of the computer system 800 is illustrated in FIG. 8 by dashed line 806.

Additionally, device 800 may also have additional features/functionality. For example, device 800 includes additional storage 808 (removable and/or non-removable) including, but not limited to, magnetic or optical disks or tape. In embodiments, a traversal algorithm component, a business object tree, or policy object tree, is stored in storage 808 and loaded into system memory 804 for use by or for execution by the processing unit 802. Computer storage media includes volatile and nonvolatile, removable and non-removable media implemented in any method or technology for storage of information such as computer readable instructions, data structures, program modules, or other data.

Memory 804 and storage 808 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage, other magnetic storage devices, or any other medium which is used to store the desired information, for example, the business object tree 100 (FIG. 1) or the policy object tree 200 (FIG. 2), and which is accessed by device 800 and processor 802. Any such computer storage media may be part of device 800.

Device 800 may also contain communications connection(s) 810 that allow the device to communicate with other devices. In embodiments, the communication connections 810 are used to send and/or receive information about the business object tree 100 (FIG. 1), send and/or receive information about the policy object tree 200 (FIG. 2) with a computer system that is accessed over a network, such as the Internet. Communications connection(s) 810 is an example of communication media. Communication media typically embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media.

In embodiments, device 800 includes a input/output devices 812. Object of interest selections for the traversal algorithm 702 (FIG. 7), in embodiments, are selected with user input device(s) 812, and the policy object associations are displayed with output device(s) 812. Input device(s) 812 are also referred to as user interface selection devices and include, but are not limited to, a keyboard, a mouse, a pen, a voice input device, a touch input device, etc. Output device(s) 812 are also referred to as displays and include, but are not limited to, cathode ray tube displays, plasma screen displays, liquid crystal screen displays, speakers, printers, etc. These devices, either individually or in combination, form the graphical user interface used to display data as described herein. All these devices are well know in the art and need not be discussed at length here.

Computer system 800 typically includes at least some form of computer readable media. Computer readable media can be any available media that can be accessed by processing unit 802. By way of example, and not limitation, computer readable media comprise computer storage media and communication media. Traversal algorithm and the related components comprise such modules or instructions executable by computer system 800 that may be stored on computer storage medium and other tangible mediums and transmitted in communication media. Computer storage media includes volatile and nonvolatile, removable and non-removable media implemented in any method or technology for storage of information such as computer readable instructions, data structures, program modules, or other data. Combinations of the any of the above should also be included within the scope of computer readable media.

In some embodiments, computer system 800 is part of a network that stores data in remote storage media for use by the computing system 800. In embodiments, a traversal algorithm 818 executing on a client system may access the remotely stored data, for example, the business object tree. In other embodiments, the computing system 800 is a desktop or similar computer that stores and operates the traversal algorithm 818 on local client data stored in a local storage medium. In still other embodiments, the traversal algorithm 818 is executed remotely on a server computer system, wherein compare results are returned to a client computer system but not generated on the client computer system.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present invention. Therefore, the specific structure, acts, or media are disclosed only as illustrative embodiments. The invention is defined by the appended claims.

What is claimed is:

1. A computer readable medium, executable on a computing system, including at least one tangible medium and encoding a computer program of instructions for executing a computer implemented method for determining one or more policy controls to be executed by an object of a business tree, the method comprising:
providing a business object tree;
providing a policy object tree;
associating the business object tree with the policy object tree;
traversing the associated business object tree and policy object tree to determine one or more policy controls in the associated policy object tree that are associated with one or more business objects in the business object tree; and
providing the one or more associated policy controls associated with the one or more business objects.

2. The computer readable medium of claim 1, wherein traversing comprises:
determining one or more business objects of interest; and
determining one or more ancestral objects for one or more of the business objects of interest.

3. The computer readable medium of claim 2, wherein one or more ancestral objects are higher order nodes to the business object of interest.

4. The computer readable medium of claim 1, further comprising:
determining one or more policy objects associated with one or more business objects of interest or one or more of the ancestral objects;
identifying one or more policy controls associated with one or more of the policy objects; and
associating the one or more policy controls with one or more of the business objects of interest.

5. The computer readable medium of claim 1, wherein the business object tree is a business object database with one or more data elements representing the one or more business objects.

6. The computer readable medium of claim 1, wherein the policy object tree is a policy object database with one or more data elements representing the one or more policy objects.

7. The computer readable medium of claim 1, wherein traversing the associated business object tree and policy object tree requires traversing links between nodes, wherein the links comprise data about relationships between nodes.

8. A computer readable medium, executable on a computing system, including at least one tangible medium and encoding a computer program of instructions for executing computer implemented components that determine one or more policy controls to be executed by an object of a business tree, the components comprising:
a control group, the control group listing one or more policy controls;
a policy object database, the policy database having one or more pointers to the control group, the policy database associating one or more policy objects with one or more policy controls;
a business object database, the business object database having one or more pointers to the policy database, the business object database associating one or more business objects with one or more policy objects;
a traversal algorithm, the traversal algorithm traversing the business object database for one or more business object of interests to determine one or more ancestral objects, the traversal algorithm traversing the policy object database to determine the one or more associated policy objects associated with the business object of interest or the ancestral objects, the traversal algorithm determining the one or more policy controls associated with the associated policy objects and to associate the one or more policy controls with the business object of interest.

9. The computer readable medium of claim 8, further comprising:
a control policy database, the control policy database associating one or more business object of interests with one or more policy controls, the control policy database output by the traversal algorithm.

10. The computer readable medium of claim 8, wherein the business object database contains a business object tree.

11. The computer readable medium of claim 10, wherein the business object database includes at least one of a business object identification, a parent object identification, or a pointer to a policy object.

12. The computer readable medium of claim 8, wherein the policy object database contains a policy object tree.

13. The computer readable medium of claim 12, wherein the policy object database includes one or more of a policy object identification or a pointer to one or more policy controls.

14. The computer readable medium of claim 8, wherein the business object database includes one or more directional links, each link representing a data element in the business object database.

15. The computer readable medium of claim 14, wherein the directional link includes at least one of a parent object identification, a child object identification, an override bit, or a type bit.

16. A method for traversing a business object tree and a policy object tree to determine one or more policy controls associated with a business object of interest in the business object tree, the method comprising:
determining one or more business objects of interest in the business object tree;
determining one or more ancestral objects for one or more of the business objects of interest;
determining one or more policy objects associated with the business object of interest or one or more of the ancestral objects;
determining one or more policy controls associated with one or more of the policy objects;
associating the one or more policy controls with the business object of interest; and
providing the one or more policy controls associated with one of the business object of interests.

17. The method of claim 16, wherein determining the one or more business object of interests comprises receiving selection of a business object of interest from a user.

18. The method of claim 16, wherein determining one or more ancestral objects comprises:
traversing one or more directional links in the business object tree, wherein the directional link is traversed if the directional link is from child to parent; and
coloring each traversed directional link to prevent twice traversing a same link in a cyclical relationship.

19. The method of claim 18, wherein the direction link includes at least one of a parent identification, a child identification, a type, or an override bit.

20. The method of claim 16, wherein the business object of interest inherits one or more policy control associations from one or more of the ancestral objects.
